(19) United States
(12) Patent Application Publication
(10) Pub. No.: US 2023/0132586 A1
(43) Pub. Date: May 4, 2023

(54) PIZZA OUTLET AND BUSINESS METHOD

(71) Applicants: Michael A. Weinstein, West Bloomfield, MI (US); Robert E. Weinstein, Miami Beach, FL (US)

(72) Inventors: Michael A. Weinstein, West Bloomfield, MI (US); Robert E. Weinstein, Miami Beach, FL (US)

(21) Appl. No.: 17/975,665

(22) Filed: Oct. 28, 2022

Related U.S. Application Data
(60) Provisional application No. 63/274,060, filed on Nov. 1, 2021.

(51) Int. Cl. A21D 13/41; A47J 44/00; G07F 11/46

(52) U.S. Cl. CPC A21D 13/41; A47J 44/00; G07F 11/46; H05B 6/64

(57) ABSTRACT

A non-pizzeria vending outlet includes a freezer, a microwave oven, and a cooktop, where the vending outlet has no means for preparing pizza dough or for baking pizza and where the vending outlet overcomes obstacles that deter non-pizzeria restaurants from vending pizza.

The present application claims priority to Provisional Application No. 63/274,060 entitled Pizza Outlet and Business Method, filed Nov. 1, 2021.

### BACKGROUND OF THE INVENTION

### 1. Field of the Invention

The present invention relates to methods and means for vending pizza that overcome barriers to vending pizza.

### 2. Description of the Prior Art

Pizza is widely acknowledged as a popular restaurant food. Restaurant sales of pizza have had a long-term growth, making pizza a desirable restaurant menu item. According to PMQ Pizza Magazine industry data, pizza sales totaled over $46 billion in the United States in 2019, in more than 77,000 pizzerias.

Conventional pizzerias ordinarily make pizza by mixing and preparing pizza dough balls, flattening the dough into pizza shape, topping the shaped dough with sauce, cheese and other toppings, and baking the pizza. Conventional pizzerias therefore require equipment that at least includes mixers to mix dough, refrigeration to refrigerate dough, cheese, meat, and other component foods, and ovens to bake pizza. Ordinary pizza production requires sufficient space to house and utilize this equipment, and staffing with individuals having expertise to execute ordinary pizza-making tasks.

The present invention recognizes that these requirements deter restaurants that are not pizzerias (herein termed “non-pizzeria restaurants”) from entering the pizza market, and that the demands of ordinarily making pizza are not suitable for restaurants that focus upon serving other foods. The invention teaches a remedy that makes it feasible for a non-pizzeria restaurant, deterred by these constraints, to now enter the pizza market and serve pizza in a fast, reliable, and non-disruptive manner.

The experience of the fast-food chain McDonald's when it attempted to introduce pizza into its menu illustrates the problems that confront a non-pizzeria restaurant attempting to introduce pizza into its menu, and exemplifies limitations even among those with immense expertise in the culinary arts.

Incentivized in the 1980s by pizza's then 10% yearly growth, McDonald's sought to expand its multi-billion dollar hamburger market by introducing pizza. A principal consideration was to establish pizza preparation operations in keeping with its “fast-food” parameters and image. The company is said to have spent ten years on this effort, many, developing a quick-cook oven that employed superheated air to take dough from frozen to crispy in under six minutes. Expanded testing began in 1989 with about 24 restaurants adopting this method at the expense of remodeling to make room for the new oven, each reputed to cost about $50,000. By some estimates, nearly 40% of their restaurants began to then serve pizza. A 1992 McDonalds commercial advertised pizza in “under 5 minutes” and that “ . . . you've never had pizza so good so fast.”

Shortly after, however, pizza disappeared from McDonald's. The Corporation issued this reason 20 years later, in 2012: “Although it was a popular menu item . . . preparation time was about 11 minutes . . . . Every McDonald's has a busy kitchen and the pizza slowed down our game . . . our pizza will have to remain a tasty bit of our history.”

In 2015, two McDonald's restaurants still offered pizza to customers, one in Pomeroy, Ohio, and one in Spencer, W. Va. A reporter visiting the West Virginia store reported waiting 10 minutes for his order to arrive, too long, and the consensus among his co-workers was that the pizza “wasn't great.”

Speed of preparation remained a crucial obstacle for McDonald's. QRS Magazine, which covers the quick service and casual restaurant industry, reported that 2019 fast-food drive-in waiting time ranged from 217 to 323 seconds: for example, 263.5 seconds for Arby's, 235.5 seconds for Burger King, 230.4 seconds for Wendy's, and 284 seconds for McDonald's. In all cases, 2019 waiting time was in the order of less than half the time it took McDonald's to serve a pizza when it attempted to do so.

While speed is critical to a fast-food restaurant wishing to serve pizza, it is not the only issue. A non-pizzeria restaurant (herein defined as one that does not primarily serve pizza) must further consider disruption from their ordinary operations, equipment needs, space limitations, and personnel requirements if it wishes to serve pizza. Further, it is presumed that the desired pizza would be at least commensurate in quality to other foods served.

What is therefore needed is a system that would allow a non-pizzeria restaurant to reliably convey a pizza to a customer within a time that is commensurate with its other foods, within floor space proportional to pizza as a menu item, in a manner that would not disrupt other operations, employing ordinary personnel, and to serve a pizza that is commensurate in quality with the restaurant's non-pizza foods.

### SUMMARY OF THE PRESENT INVENTION

The invention rests upon recognizing the aforementioned barriers that continue to prevent non-pizzeria restaurants from entering the pizza market, and recognizing a remedy that would now allow such food vendors to reliably prepare and serve pizza quickly, within commensurate space, without disrupting other restaurant operations, and utilizing ordinary restaurant workers.

The present invention is based upon considerable experimentation and decades-long experience operating conventional pizzerias (MW) that serve artisan pizza recognized by critical review including Food Network Magazine: “The Best Pizza in Michigan”; Ed Levine, Serious Eats: “Our 30 Favorite Pizzerias”; Alan Richman GQ Magazine: “The 25 Best Pizzas in America.”

The inventors have found a method whereby a pizza, including its own artisan pizza, can be frozen and later quickly and reliably reconstituted, such that it has the attributes of taste, crispiness and mouth-feel of the original pizza. The method employs a “microwave-crisping method,” namely a complementary procedure of microwave thawing and heating of a frozen pizza followed by a crisping step of conduction heating to crisp the crust bottom, for example, on a stovetop pan, or hot plate.

The term “microwave-crisping method” is herein used interchangeably with “microwave-crisping” to refer to heating a frozen pizza in a microwave oven and then crisping the pizza crust upon a conduction heat source, or “cooktop,” for example, a hot plate, grille (griddle), or stovetop pan. This method is disclosed and elaborated upon in prior published applications of Weinstein, et. al.

These applications teach that the fastest method to thaw and reheat a frozen pizza is by microwave heating, whereby an individual or shared-sized pizza can be thawed and heated in a few minutes. The applications acknowledge two drawbacks of microwave heating a frozen pizza: 1. That it results in a soggy crust because microwaves predominately act to heat water, and 2. That it heats foods unevenly. The applications teach overcoming both problems with a second step of heating the bottom of the microwave thawed and warmed pizza directly on a conduction heat source. This was found to quickly and reliably even out the heating of the pizza and result in a crisp crust.

In view of this, the inventors introduced a packaged frozen pizza for retail grocery sale. The packaging promoted hot pizza with a crisp crust within three minutes.

Specifically, the package contained a 9.7 ounce (276 gram) frozen pepperoni pizza on a paper tray, and had illustrated instructions to microwave the pizza on the tray for two minutes, transfer the pizza to a heated stovetop pan by holding the tray, and then crisping the pizza crust for about one minute at high heat.

To the inventor's dismay, the product failed to sell, even despite demonstrations to promote the product and teach the method. The inventors therefore abandoned selling to consumers.

This hard-learned experience, however, led to further consideration and insight where it was recognized that despite being inappropriate for use by consumers, the microwave-crisping method can be employed to overcome the common barriers to entry (speed of preparation, reliability, cost to initiate, space requirements, avoidance of operational disruption, and need for expert pizza makers to ordinarily make pizza) facing non-pizzeria restaurants that wish to serve pizza, especially fast food restaurants.

To the inventor's knowledge, there is presently no non-pizzeria restaurant that employs or has employed the microwave-crisping method to enter the pizza market and vend pizza. This is despite allowing for a small footprint, costing a fraction of the investment compared to a conventional pizzeria, utilizing inexpert personnel that can be easily trained, and offering the ability to quickly and reliably serve pizza having qualities as desired.

Moreover, to the inventor's knowledge, there has been no instance where the microwave-crisping method of preparing pizza has occurred to those in the art of vending pizza as a way to overcome the barriers that non-pizzeria restaurants and fast-food non-pizzeria restaurants face if they wish to vend pizza as illustrated in the case of McDonalds.

Accompanying FIGS. 1-5 serve to illustrate the application of the present invention to vending pizza.

### BRIEF DESCRIPTION OF THE DRAWINGS

FIG. 1 is a schematic depiction of a floor plan of a conventional pizzeria kitchen.

FIG. 2 is a frontal planar view of a pizza preparation module of the present invention.

FIG. 3 is a top view of the floor space occupied by the pizza preparation module depicted in FIG. 2 and its adjacent work area.

FIG. 4 is a frontal planar view of a pizza preparation module alternative of the present invention.

FIG. 5 is a top view of the floor space occupied by the pizza preparation module depicted in FIG. 4 and its adjacent work area.

### DETAILED DESCRIPTION OF THE INVENTION

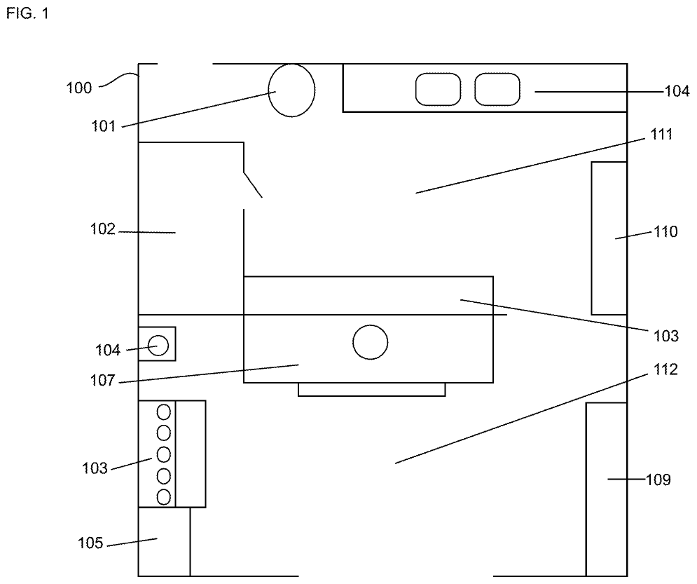

Referring to FIG. 1, the floor plan schematically depicts a small kitchen equipped to conventionally make pizza 100, and is similar to one of the inventor's (MW) pizzerias. The starting point is preparing dough, ordinarily in 50-60 pound batches, utilizing means to mix the dough, a mixer 101 shown schematically. A walk-in refrigerator 102 is depicted, measuring perhaps 60-80 square feet in size for perishable foods including meats, cheese, vegetables, and to refrigerate prepared dough. Further means to prepare dough include a worktable 103 to provide a surface to shape dough into pizza balls and to prepare pizza cheeses and toppings, adding to workspace. Sink areas 104 are required to wash foods and utensils and comply with cleanliness standards. Some washing equipment may be automated.

Moving from the pizza preparatory area 111 to the pizza assembly and baking area 112, a “bang-out” table is depicted 105 where the pizza balls are flattened into pizza shape, either by hand, or with machinery. The refrigerated “prep-table” 106 facilitates applying refrigerated sauces and toppings on the pizza dough situated on a pizza peel, prior to transferring it to a baking means, ordinarily an oven, and baking the pizza in the oven 107. A deck oven is depicted. Such ovens require mechanical ventilation equipment, a further expense, depicted by the circle in the oven. When the pizza is fully baked to the satisfaction of the baker, the baker removes it to the cut station table 109 where it is cut, and either served or boxed. Alternative oven (baking means) options include conveyor type ovens that are less labor intensive and require less baking expertise, but ordinarily require more space than a deck oven. Area 110 is intended to represent storage that might include canned foods, flour, utensils, and cleaning materials. A small pizza kitchen of this type would require approximately 700-800 square feet.

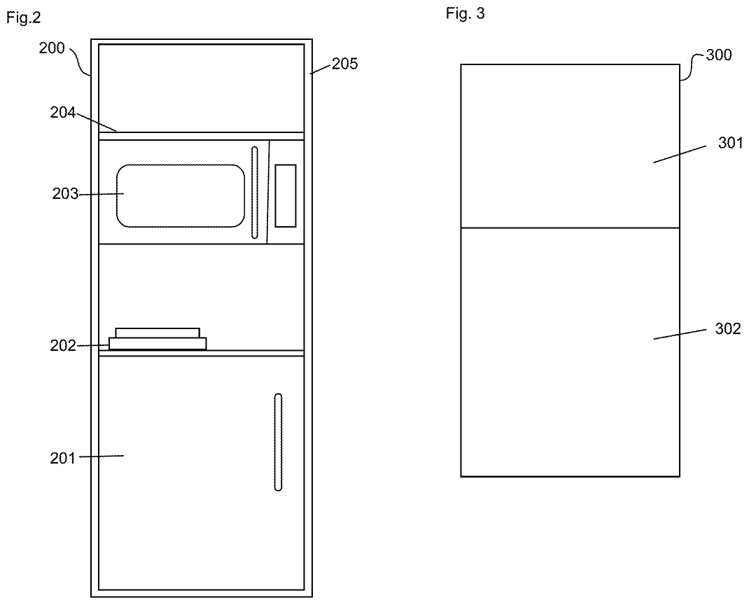

FIG. 2 exemplifies a pizza preparation module 200 of the present invention in schematic frontal planar view. The module contains a refrigeration unit 201 that is preferably a freezer, a microwave oven 203, and a conduction heat device 202, such as a hot plate, a griddle (or grille), or a stovetop pan above a heat source. 204 depicts an optional shelf above the microwave oven that might support a second microwave oven, or a shelf to hold heated pizzas under a heat lamp and/or where the shelf is heated to keep the pizzas warm, as is known in the art. The entire module 200, is unified by a rack 205, of wood, metal or other material, and of desired size and configuration to organize the desired components. It is to be understood that a compact configuration is illustrated and that configurations other than as depicted yet advantageous to unify the freezer and microwave and cooktop components as might best fit into a particular restaurant are within the realm of the present invention. Notably the module 200 does not incorporate means to prepare pizza dough such as a mixer, or means to bake a pizza such as an oven.

To prepare pizza for serving according to the microwave-crisping method, the preparer would remove the pizza from the refrigeration unit 201, place it in a microwave oven 203 and microwave it for a determined period of time, remove it from the microwave oven 203, and heat the bottom of the pizza on the conduction source 202 to even out the microwave heating and crisp the crust. Depending upon pizza size, it is anticipated for this process to require three minutes or less for an individual pizza serving, and for even an inexpert individual to prepare about 18 pizzas an hour, perhaps 35 with a second microwave oven.

FIG. 3 exemplifies the floor space 300 occupied by a pizza preparation module 301 of the present invention and its adjacent work area 302 in schematic top view. A typical module 301 such as illustrated in FIG. 2 can be designed to occupy space of about 2.5′×3.0 feet or 7.5 square feet, and the adjacent work area to occupy about the same, in total 15 square feet. This pizza preparation space of 20 square feet is seen to be negligible when compared to the greater than 700 square feet required to conventionally prepare pizza, as exemplified in FIG. 1.

It is to be understood that depending upon production need and configuration of the non-pizzeria restaurant kitchen, this most compact configuration might be duplicated, or the layout rearranged if, for example, the equipment is used for other foods, or rearrangement is necessary for the equipment to more favorably fit into the restaurant and not disrupt ordinary operations.

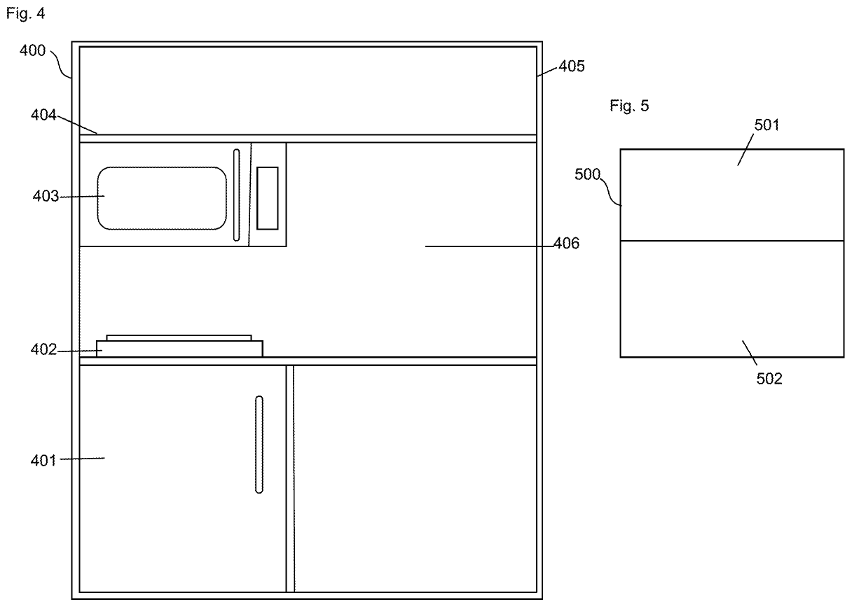

FIG. 4 depicts an alternative microwave-crisping pizza vending outlet, comparable to FIG. 2 but larger. The module contains a freezer 401, a microwave oven 403, and a conduction heat source 402, such as a hot plate, a griddle (or grille), or a stovetop pan above a heat source. 404 depicts an optional shelf above the microwave oven that might support a second microwave oven, or a shelf to hold heated pizzas under a heat lamp and/or where the shelf is heated to keep the pizzas warm, as is known in the art. The module 400, is preferably unified by an organizing rack 405 of wood, metal or other material. The module optionally has an open space 406 where a vendor preparing pizza can face customers, such that the module is akin to a vending stand. The area next to the freezer can be used for storage or for another refrigeration unit.

FIG. 5 is a schematic top planar view that exemplifies the floor space 500 of pizza preparation module 501 and its adjacent work area 502. The vending stand 501 such as illustrated in FIG. 5 can be designed to occupy space of about 2.5×6.0 feet, and the adjacent work area to occupy perhaps 3.5″×6.0 feet, perhaps a total of 36 square feet, again negligible when compared to the greater than 700 square feet required to conventionally prepare pizza, as exemplified in FIG. 1.

With regard to the microwave-crisping method, it is recognized that a vender who elects to vend pizza according to this method is required to prepare a frozen pizza at a facility apart from where it is vended, or source and obtain a frozen pizza apart from where it is vended.

Further, as to microwave heating, it is to be understood that the temperature attained within a particular time is proportional to the size of the frozen pizza. To exemplify this, an 80 gram frozen pepperoni pizza sample was found to be sufficiently thawed and heated to approximate serving temperature in about 40 seconds in a 1000 watt output microwave oven, whereas a 270 gram frozen pizza sample requires about 120 seconds (two minutes). In one experiment using two minute microwave heating of a 270 gram frozen pizza sample, temperatures as measured with an infrared thermometer ranged from 96 to 173 degrees F. on the top of the pizza, and 98 to 127 degrees F. on the bottom crust side. The microwaved pizza was soggy and drooped upon lifting.

When the microwaved pizza was placed on a stovetop pan at 380-400 degrees F., sufficient crisping was seen to occur in about 60 seconds with a resultant crisp crust bottom ranging from 200 degrees F. to 230 degrees F., and the pizza was found to be more rigid on lifting.

In further experiments, early crust burning was found to begin at about 90 seconds, leaving leeway before over-crisping or burning the crust. It is considered that moisture mobilized by microwave heating protects the crust from burning when subsequently crisping the pizza,

Accordingly, the fastest, and most forgiving process for a non-pizzeria restaurant to prepare frozen pizza is herein considered to be to: microwave the pizza to approach consumption temperature, and then heat the pizza bottom atop a heated cooktop for a relatively short period of 30-90 seconds to crisp the bottom. A desirable consumption or serving temperature is herein intended to indicate about 140° F., but preferably higher, in the range of 150-180° F.

It is considered that when generating a soggy pizza crust before crisping, a paradoxically desirable outcome is attained of achieving a moist crust layer situated above a crisped crust bottom as has been favored by pizza afficionados.

It is further recognized that microwave heating pizza to at least approach a consumption temperature can be performed starting at any temperature, as frozen, refrigerator temperature, room temperature, or higher, to shorten the microwave heating step. A non-pizzeria restaurant may therefore opt to remove frozen pizzas from the freezer that it expects to sell, and thaw or warm them prior to final preparation for a diner. This might result in a more rapid preparation process, or suffer drawbacks of waste and spoilage. In light of the speed of microwave heating of pizza, time saving would be expected to be marginal, however this practice is anticipated within the present invention.

The uneven nature of microwave heating is well recognized and is above exemplified by temperature ranges. Strategies as rotating microwave oven trays, raising food above the microwave oven floor, repositioning during microwave cooking, using a microwave oven that best distributes microwave energy, using convection circulation during microwave heating, and covering the food thereby trapping heat are known in the art and such methods to promote even microwave heating are considered within the present invention.

It is herein considered that cooktop crisping surfaces of the present invention constitute heated flat surfaces, examples being griddles, also known as flat grills, and stovetops with stovetop pans. Crisping upon such a surface is anticipated at a temperature above about 350° F. to achieve a Maillard crisping effect, and preferably higher for speed.

It is an insight of the present invention that a non-pizzeria restaurant can serve a pizza having a quality of it's choosing, even of artisan quality as the attributes of the pizza before freezing, that is, taste, mouth feel, chewiness, and texture have been found to be largely reestablished after pizza preparation by microwave-crisping.

This especially pertains to the pizza crust that strongly factors into the perception of pizza quality. When pizzas were prepared with an intention of achieving an artisan quality by being baked directly upon a brick in a pizzeria oven, and then frozen, when later prepared by microwave-crisping, the pizza were judged by the inventors and other tasters as being very similar or almost identical as before freezing.

In a further experiment the pizza was prepared by baking in a pan or a grate, and not directly on the brick. The resulting crust had different attributes (not as chewy, different mouth-feel). It was speculated that the microwave-crisping method might improve upon the attributes of the pizza and even achieve the qualities of a pizza baked directly on a brick oven floor, since the pizza is later crisped while sitting directly atop a hot surface akin to a brick oven floor. This was not the case and the pan-baked pizza was found to have essentially the same attributes as before freezing. It is therefore anticipated that that the intended qualities of the pizza for microwave-crisping in a non-pizzeria restaurant need be generated before freezing the pizza.

Note is made of “microwave-convection ovens” have been newly developed and marketed and that have heating capabilities that include convection heating, air frying, and broiling in addition to microwave heating. The inventors have tried to reproduce the effect of microwave-crisping of frozen pizza using a GE microwave-convection oven and have met with limited success in crisping pizza crust or producing a crisp crust with a moist layer atop it. The potential to reproduce the described effects of the sequence of microwave-crisping with further technologic development is herein anticipated and deemed to be within the scope of the invention, for example programming that would result in a thawing-crisping sequence and/or the production of more intense conduction heating to heat the crust than we have been able to achieve.

It is herein noted that food preparation is an art and that preparing desirable pizza is a multifactorial art. The attainment of speed, reliability, and desirable outcomes is dependent not only upon temperature and time, but at least, also upon pizza formulation, crust dough moisture content, toppings, differences in microwave oven characteristics, positioning of the pizza in the microwave oven, cooktop configurations, cooktop temperature, and cooktop surfaces. Adjustments of conditions to reliably achieve a hot pizza with a moist crust and a crisp crust bottom are anticipated and considered within the present methods, such as evenly spreading toppings when manufacturing the pizza to favor even microwave heating of the pizza, adding moisture to the pizza during crisping, and crisping on a surface that is not an ordinary metallic griddle surface or pan, but on another material, for example, a heated porous material like terra cotta. Transfer of hot pizza from microwave oven to crisping surface is anticipated to be accomplished by a variety of means as are known in the art, as upon a planar substrate situated under the pizza, a pizza peel, a spatula, and further means as previously disclosed. It is anticipated for removing pizza from the crisping surface to include sliding it from a pan, or lifting upon a planar surface as a spatula, or lifting with tongs, and then serving the pizza on a plate, in a container, on a napkin, or other serving means as is known in the art. It is recognized that transfers of pizza are facilitated where the pizza does not have sauce or toppings at its periphery that might stick to cooking surfaces, and it is preferred for the pizza to have a peripheral crust devoid of sauce or toppings.

Although the preferred embodiments and methods of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A non-pizzeria vending outlet comprising:
a freezer;
a microwave oven; and
a cooktop,
wherein the vending outlet has no means for preparing pizza dough or for baking pizza and wherein the vending outlet overcomes obstacles that deter non-pizzeria restaurants from vending pizza.

2. The vending outlet of claim 1, wherein the obstacles include speed of preparation, pizza quality, floor space requirement, operational disruption, equipment costs, and need for pizza-making expertise.

3. The vending outlet of claim 1, wherein the vending outlet is a fast-food vending outlet.

4. The vending outlet of claim 3, wherein the speed of preparation is a crucial obstacle.

5. A system to allow a non-pizzeria restaurant to overcome obstacles that deter such restaurants from vending pizza that include speed of preparation within a time commensurate with its other foods, pizza quality commensurate with the quality of its non-pizza foods, floor space requirements and equipment costs proportional to pizza as a menu item, production in a manner that would not disrupt other operations, and production without need for pizza-making expertise, comprising the steps of:
obtaining a frozen pizza;
obtaining a freezer, a microwave oven, and a cooktop to prepare the frozen pizza for serving to a customer;
storing the frozen pizza in the freezer;
preparing the frozen pizza for the customer by microwave heating and then crisping the pizza creating a heated and crisped pizza;
conveying the heated and crisped pizza to the customer.

6. The method of claim 5, wherein the non-pizzeria restaurant is a fast-food restaurant.

7. The method of claim 6, wherein the obstacles include a crucial obstacle that is speed of preparation wherein the speed of preparation is similar to the speed of preparing other fast-food items of the fast-food restaurant.
